(19) United States
(12) Patent Application Publication
(10) Pub. No.: US 2014/0342587 A1
(43) Pub. Date: Nov. 20, 2014

(54) CONNECTOR ASSEMBLY

(71) Applicant: Hon Hai Precision Industry Co., Ltd., New Taipei (TW)

(72) Inventors: YI-FANG WU, New Taipei (TW); FOO SEE WOEI, Shenzhen (MY)

(73) Assignee: HON HAI PRECISION INDUSTRY CO., LTD., New Taipei (TW)

(21) Appl. No.: 14/137,224

(22) Filed: Dec. 20, 2013

(30) Foreign Application Priority Data
May 16, 2013 (CN) 2013101807047

(51) Int. Cl. H01R 13/447

(52) U.S. Cl. CPC H01R 13/447
USPC 439/135

(57) ABSTRACT

A connector assembly includes a connecting body and a protecting cover mounted to the connecting body. The connecting body defines a limiting hole and includes a guiding portion. The guiding portion includes a limiting bar. A first guiding bar and a second guiding bar extend from the limiting bar. The first guiding bar and the second guiding bar cooperatively define a first sliding slot. The protecting cover includes a second hook and an engaging portion. An accommodating space is defined in the protecting cover. The engaging portion includes a first engaging bar and a second engaging bar. The second hook is locked in the limiting hole. The first engaging bar is slidable in the first sliding slot. The limiting bar is locked between the first engaging bar and the second engaging bar. A plurality of connecting lines extends out of the protecting cover from the accommodating space.

### BACKGROUND

1. Technical Field

The present disclosure relates to a connector assembly with protecting cover.

2. Description of Related Art

Connectors are widely used on printed circuit boards (PCBs) and cable assembly. A conventional connector includes an inserting portion and a plurality of connecting lines extending from the inserting portion. The plurality of connecting lines usually are exposed, which may be dangerous.

Therefore, there is a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric, exploded view of an embodiment of a connector assembly, viewed from a first aspect.

FIG. 2 is an isometric, exploded view of an embodiment of a connector assembly, viewed from a second aspect.

FIG. 3 is an isometric, exploded view of an embodiment of a connector assembly, viewed from a third aspect.

FIG. 4 is an assembled view of the connector assembly of FIG. 1.

FIG. 5 is an assembled view of the connector assembly of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

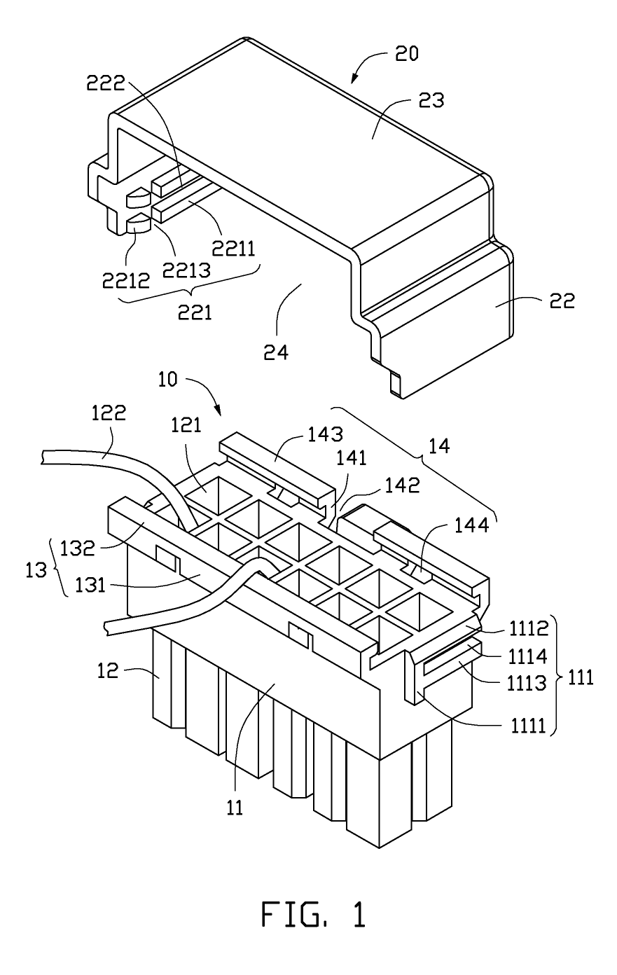

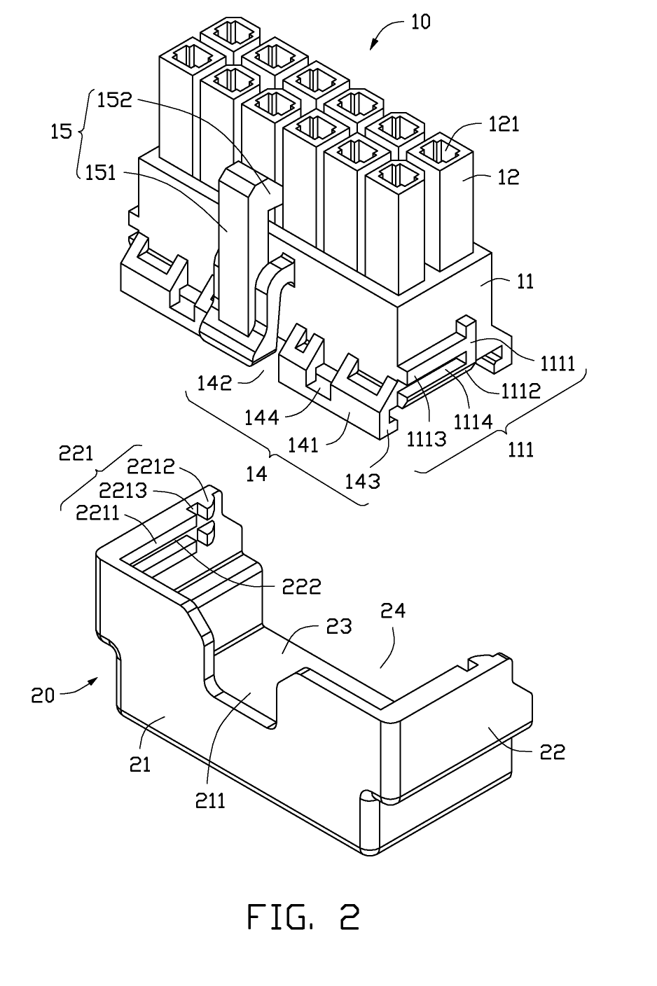

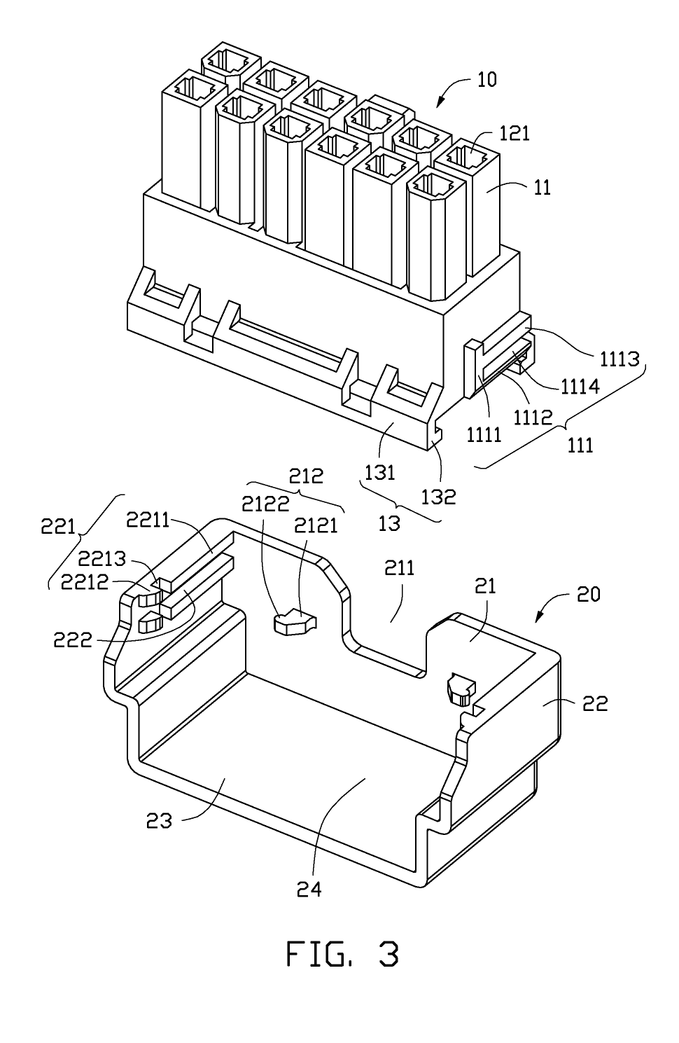

FIGS. 1 to 3 show a connector assembly in accordance with one embodiment. The connector assembly includes a connecting body 10 and a protecting cover 20 mounted to the connecting body 10.

The connecting body 10 includes a mounting portion 11 and a plurality of inserting portions 12 substantially perpendicularly extending from the mounting portion 11. Each of the plurality of inserting portions 12 defines a substantially rectangular accommodating hole 121. The accommodating holes 121 extend through the mounting portion 11. A plurality of connecting lines 122 passes through the accommodating holes 121. A first limiting portion 13 and a second limiting portion 14 extend from two opposite sides of the mounting portion 11. Two guiding portions 111 protrude from another two opposite sides of the mounting portion 11. Each of the two guiding portions 111 includes a limiting bar 1111. A first guiding bar 1112 and a second guiding bar 1113 substantially perpendicularly extend from the limiting bar 1111. The first guiding bar 1112 and the second guiding bar 1113 cooperatively define a first sliding slot 1114.

The first limiting portion 13 includes a first connecting wall 131 substantially perpendicularly extending from a first side edge of the mounting portion 11. A first top wall 132 substantially horizontally extends from a top edge of the first connecting wall 131. The second limiting portion 14 includes a second connecting wall 141 substantially perpendicularly extending from a second side edge of the mounting portion 11. A first cutout 142 is defined in the second connecting wall 141. A second top wall 143 substantially horizontally extends from a top edge of the second connecting wall 141. Two limiting holes 144 are defined between the mounting portion 11 and the second connecting wall 141. The two limiting holes 144 are positioned on two sides of the first cutout 142. A first hook 15 is formed on the mounting portion 11 adjacent to the first cutout 142. The first hook 15 includes a first connecting portion 151 connected to the mounting portion 11. A first locking portion 152 extends from a distal end of the first connecting portion 151.

In one embodiment, each of the first guiding bars 1112 is substantially parallel to each of the second guiding bars 1113. The first connecting portion 151 is an elastic bracket. The first hook 15 is adapted to lock on a female connector (not shown). The connecting body 10 is electrically connected to the female connector by the plurality of connecting lines 122.

The protecting cover 20 includes a third connecting wall 21 and two ladder-shaped sidewalls 22 substantially perpendicularly extending from two opposite sides of the third connecting wall 21. A third top wall 23 substantially perpendicularly connects to the third connecting wall 21 and the two sidewalls 22. A second cutout 211 is defined in the third connecting wall 21. Two second hooks 212 substantially perpendicularly extend from the third connecting wall 21. The two second hooks 212 are positioned on two sides of the second cutout 211. Each of the two second hooks 212 includes a second connecting portion 2121 substantially perpendicularly extending from the third connecting wall 21. A second locking portion 2122 extends from a distal end of the second connecting portion 2121. In one embodiment, the second connecting portions 2121 are elastic brackets. A width of each of the second connecting portions 2121 is less than a width of each of the two limiting holes 144. A width of each of the second locking portions 2122 is substantially equal to a width of each of the two limiting holes 144.

Two engaging portions 221 protrude from each of the two sidewalls 22. The two engaging portions 221 cooperatively define a second sliding slot 222. Each of the engaging portions 221 includes a first engaging bar 2211 and a second engaging bar 2212. The first engaging bar 2211 and the second engaging bar 2212 cooperatively define a third cutout 2213. The third connecting wall 21, the two sidewalls 22 and the third top wall 23 cooperatively define an accommodating space 24. The plurality of connecting lines 122 extends to an outside of the protecting cover 20 from a front side of the accommodating space 24.

In one embodiment, the two sidewalls 22 are elastic brackets. A width of each of the engaging portions 221 is substantially equal to a width of each of the first sliding slots 1114. A width of each of the second guiding bars 1113 is substantially equal to a width of each of the second sliding slots 222. The first engaging bars 2211 are substantially parallel to each other on each of the two sidewalls 22, and the second engaging bars 2212 are substantially parallel to each other on each of the two sidewalls 22. One terminal of each of the second engaging bars 2212 is arc-shaped.

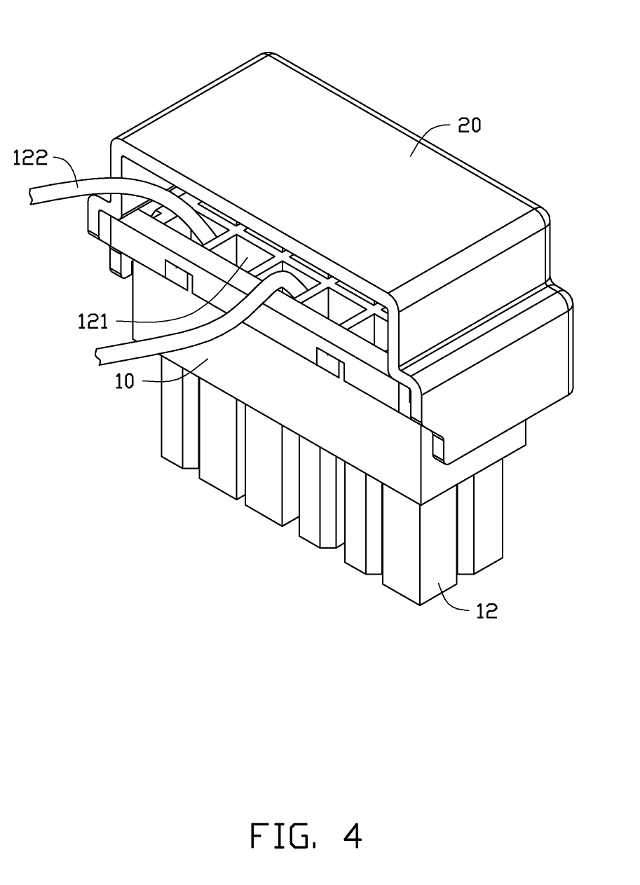

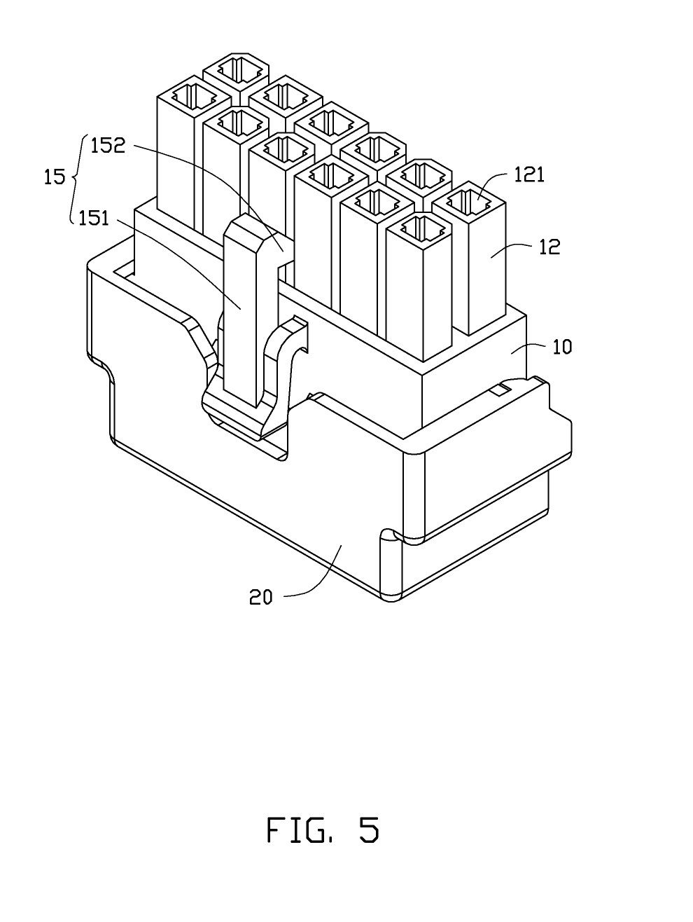

FIGS. 4 and 5 show that in use, the two second hooks 212 of the protecting cover 20 are aligned with the two limiting holes 144 of the connecting body 10. The first engaging bars 2211 are aligned with the first sliding slots 1114. The second sliding slots 222 are aligned with the second guiding bars 1113. The protecting cover 20 is moved toward the connecting body 10. The first engaging bars 2211 are slid in the first sliding slots 1114. The second guiding bars 1113 are slid in the second sliding slots 222. The two limiting holes 144 resist against the second locking portions 2122. The second connecting portions 2121 are elastically deformed slightly. The limiting bars 1111 resist against the second engaging bars 2212. The two sidewalls 22 are elastically deformed slightly.

The protecting cover 20 continually moves toward the connecting body 10 until the second locking portions 2122 are locked in the two limiting holes 144. The limiting bars 1111 pass through the second engaging bars 2212 and are aligned with the third cutouts 2213. The second connecting portions 2121 and the two sidewalls 22 elastically return. The limiting bars 1111 are locked in the third cutouts 2213 between the first engaging bars 2211 and the second engaging bars 2212. The first hook 15 is received in the second cutout 211. The protecting cover 20 is mounted to the connecting body 10. The first connecting wall 131 and the first connecting portion 151 are pressed to rise up the first locking portion 152 slightly. The plurality of inserting portions 12 is moved toward the female connector until the plurality of connecting lines 122 is electrically connected to the female connector. The first connecting portion 151 is released. The first locking portion 152 elastically returns and locks on the female connector. The protecting cover 20 shields and protects the plurality of connecting lines 122 in the connecting body 10. Therefore, danger caused by wear of the plurality of connecting lines 122 is avoided.

Even though numerous characteristics and advantages of the present disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. A connector assembly, comprising:
a connecting body defining a limiting hole and comprising a guiding portion; wherein the connecting body is configured to accommodate a plurality of connecting lines; the guiding portion comprises a limiting bar; a first guiding bar and a second guiding bar extend from the limiting bar; the first guiding bar and the second guiding bar cooperatively define a first sliding slot; and
a protecting cover mounted to the connecting body; wherein the protecting cover comprises a second hook and an engaging portion; an accommodating space is defined in the protecting cover; the engaging portion comprises a first engaging bar and a second engaging bar; the second hook is locked in the limiting hole; the first engaging bar is slidable in the first sliding slot; the limiting bar is locked between the first engaging bar and the second engaging bar; and the plurality of connecting lines extends to an outside of the protecting cover from the accommodating space.

2. The connector assembly of claim 1, wherein the connecting body comprises a mounting portion; a first limiting portion and a second limiting portion extend from two opposite sides of the mounting portion; the first limiting portion comprises a first connecting wall substantially perpendicularly extending from the mounting portion; and a first top wall substantially horizontally extends from the first connecting wall.

3. The connector assembly of claim 2, further comprising a plurality of inserting portions substantially perpendicularly extending from the mounting portion; each of the plurality of inserting portions defines an accommodating hole; the accommodating holes extend through the mounting portion; the plurality of connecting lines passes through the accommodating holes; and the connecting body is electrically connected to a female connector by the plurality of connecting lines.

4. The connector assembly of claim 2, wherein the second limiting portion comprises a second connecting wall substantially perpendicularly extending from the mounting portion; a second top wall substantially horizontally extends from the second connecting wall; and the limiting hole is defined between the mounting portion and the second connecting wall.

5. The connector assembly of claim 3, wherein the mounting portion further comprises a first hook; the first hook comprises a first connecting portion connected to the mounting portion; a first locking portion extends from the first connecting portion; and the first locking portion locks on the female connector.

6. The connector assembly of claim 5, wherein the protecting cover comprises a third connecting wall and two sidewalls substantially perpendicularly extending from the third connecting wall; a third top wall substantially perpendicularly connects to the third connecting wall and the two sidewalls; the second hook extends from the third connecting wall; the second hook comprises a second connecting portion substantially perpendicularly extending from the third connecting wall; a second locking portion extends from the second connecting portion; and the third connecting wall, the two sidewalls and the third top wall cooperatively define the accommodating space.

7. The connector assembly of claim 6, wherein the engaging portion protrudes from the sidewall; the first engaging bar and the second engaging bar cooperatively define a third cutout; and the limiting bar is locked in the third cutout between the first engaging bar and the second engaging bar.

8. The connector assembly of claim 7, wherein the first guiding bar is substantially parallel to the second guiding bar.

9. The connector assembly of claim 6, wherein the first connecting portion, the second connecting portion and the two sidewalls are elastic brackets; a width of the second connecting portion is less than a width of the limiting hole; a width of the second locking portion is substantially equal to a width of the limiting hole; and a width of the engaging portion is substantially equal to a width of the first sliding slot.

10. A connector assembly, comprising:
a connecting body comprising a mounting portion and a guiding portion and defining a limiting hole; wherein a plurality of inserting portions substantially perpendicularly extends from the mounting portion; each of the plurality of inserting portions defines an accommodating hole; the accommodating holes extend through the mounting portion; the accommodating holes are configured to accommodate a plurality of connecting lines; the guiding portion comprises a limiting bar; a first guiding bar and a second guiding bar extend from the limiting bar; the first guiding bar and the second guiding bar cooperatively define a first sliding slot; and
a protecting cover mounted to the connecting body; wherein the protecting cover comprises a second hook and an engaging portion; an accommodating space is defined in the protecting cover; the engaging portion comprises a first engaging bar and a second engaging bar; the second hook is locked in the limiting hole; the first engaging bar is slidable in the first sliding slot; the limiting bar is locked between the first engaging bar and the second engaging bar; and the plurality of connecting lines extends to an outside of the protecting cover from the accommodating space.

11. The connector assembly of claim 10, further comprising a first limiting portion and a second limiting portion extend from two opposite sides of the mounting portion; the first limiting portion comprises a first connecting wall substantially perpendicularly extending from the mounting portion; and a first top wall substantially horizontally extends from the first connecting wall.

12. The connector assembly of claim 11, wherein the connecting body is electrically connected to a female connector by the plurality of connecting lines.

13. The connector assembly of claim 11, wherein the second limiting portion comprises a second connecting wall substantially perpendicularly extending from the mounting portion; a second top wall substantially horizontally extends from the second connecting wall; and the limiting hole is defined between the mounting portion and the second connecting wall.

14. The connector assembly of claim 12, wherein the mounting portion further comprises a first hook; the first hook comprises a first connecting portion connected to the mounting portion; a first locking portion extends from the first connecting portion; and the first locking portion locks on the female connector.

15. The connector assembly of claim 14, wherein the protecting cover comprises a third connecting wall and two sidewalls substantially perpendicularly extending from the third connecting wall; a third top wall substantially perpendicularly connects to the third connecting wall and the two sidewalls; the second hook extends from the third connecting wall; the second hook comprises a second connecting portion substantially perpendicularly extending from the third connecting wall; a second locking portion extends from the second connecting portion; and the third connecting wall, the two sidewalls and the third top wall cooperatively define the accommodating space.

16. The connector assembly of claim 15, wherein the engaging portion protrudes from the sidewall; the first engaging bar and the second engaging bar cooperatively define a third cutout; and the limiting bar is locked in the third cutout between the first engaging bar and the second engaging bar.

17. The connector assembly of claim 16, wherein the first guiding bar is substantially parallel to the second guiding bar.

18. The connector assembly of claim 15, wherein the first connecting portion, the second connecting portion and the two sidewalls are elastic brackets; a width of the second connecting portion is less than a width of the limiting hole; a width of the second locking portion is substantially equal to a width of the limiting hole; and a width of the engaging portion is substantially equal to a width of the first sliding slot.
